(19) United States
(12) Patent Application Publication
(10) Pub. No.: US 2013/0036361 A1
(43) Pub. Date: Feb. 7, 2013

(54) System and Method of Relating Resources and Business Objects of Different Business Object Types

(71) Applicant: Stefan Manuel Fischer, Frankenthal (DE)

(72) Inventor: Stefan Manuel Fischer, Frankenthal (DE)

(73) Assignee: SAP AG, Walldorf (DE)

(21) Appl. No.: 13/196,164

(22) Filed: Aug. 2, 2011

(51) Int. Cl. G06F 3/01; G06F 15/16

(52) U.S. Cl. 715/738

(57) ABSTRACT

A system and method of relating resources and business objects. The method includes storing business objects by a first application server and a second application server, where the first application server is configured to access a business object of a first business object type and the second application server is configured not to access the business object of the first business object type. The method further includes storing resources, and relationships between the business objects and the resources. The method further includes generating an object view in which, for a selected business object, a first relationship is editable according to a first user input, where the first relationship relates the selected business object to one of the resources. The method further includes generating a resource view in which, for a selected resource, at least one associated business object and at least one associated relationship are viewable, where the at least one associated relationship relates the selected resource and the at least one associated business object. In this manner, resources may be scheduled despite the underlying applications not being able to access all the types of business objects.

### CROSS REFERENCE TO RELATED APPLICATIONS

Not applicable.

### BACKGROUND

1. Field of the Invention

The present invention relates to resource management, and in particular, to resource management using business object types.

2. Description of the Related Art

Unless otherwise indicated herein, the approaches described in this section are not prior art to the claims in this application and are not admitted to be prior art by inclusion in this section.

Scheduling employees to work at a business location is often automated. When multiple employees are available to work at multiple locations, the scheduling system may perform load balancing to allocate similar coverage of employees to all the locations. An example of this type of system is described in U.S. Application Pub. No. 2005/0137927.

Additionally, scheduling the time of individual employees is often automated. When an employee is available within a larger time period, the employee's time may be scheduled into shorter time periods. The scheduling system may receive a first request providing the availability within the larger time period, may receive a second request providing a desired availability within a shorter time period, and may then perform scheduling to take both these requests into account when scheduling the employee's time. An example of this type of system is described in U.S. Application Pub. No. 2005/0222884.

### SUMMARY

Given the above background, there is a need to assign resources to projects in ways other than when the projects are all stored by the same homogeneous computing environment.

One embodiment includes a method of relating resources and business objects. The method includes storing business objects by a first application server and a second application server, where the first application server is configured to access a business object of a first business object type and the second application server is configured not to access the business object of the first business object type. The method further includes storing resources, and relationships between the business objects and the resources. The method further includes generating an object view in which, for a selected business object, a first relationship is editable according to a first user input, where the first relationship relates the selected business object to one of the resources. The method further includes generating a resource view in which, for a selected resource, at least one associated business object and at least one associated relationship are viewable, where the at least one associated relationship relates the selected resource and the at least one associated business object. In this manner, resources may be scheduled despite the underlying applications not being able to access all the types of business objects.

The user input may add (or remove) resources (from a selected business object) or business objects (from a selected resource) by editing the relationships. The relationships may be edited by editing their relationship attributes. The application servers may be heterogeneous.

A system may perform the above method. The system may include a number of application servers that are configured to perform steps of the method, e.g., as one or more hardware servers executing one or more computer programs.

A non-transitory computer readable medium may store instructions that correspond to the above method. The instructions may be arranged as subprograms or components that may be executed by one or more application servers (which may be implemented by one or more hardware servers).

An embodiment may have one or more of the following features. First, it allows for resource assignment in a heterogeneous environment. (Otherwise the heterogeneous components would each need to be modified to work with each other heterogeneous component.)

Second, it allows for resource scheduling for newly-added applications. When a new type of business object is added, the tools used to create the new application may be the same tools used to access that new business object type in the scheduling program. (Otherwise the newly-added application may have a new type of business object that requires reprogramming of the scheduling application before the scheduling application can access the new type of business object; or reports from both applications must be generated and then combined together.) For example, Company X has a project management system (for tracking projects) and a customer relationship management system (for tracking sales orders) that are staffed from the same set of employees; an embodiment may be used to generate a consistent view of the assigned employees to both sales orders and projects.

Third, it allows for one consistent view on resources in a heterogeneous environment. (Otherwise each heterogeneous application would need to be modified according to each other heterogeneous application in order to pull the resource data from the other heterogeneous applications.)

Fourth it easily allows extension to new entities to assign (“schedule”) resource against. The benefit of this is greater flexibility for workforce dominated companies (usually service providers) working in heterogeneous lines of business.

The following detailed description and accompanying drawings provide a better understanding of the nature and advantages of the present invention.

### BRIEF DESCRIPTION OF THE DRAWINGS

FIG. 1 is a block diagram of a system for relating resources and business objects, according to an embodiment.

FIG. 2 is a block diagram of a three tier architecture system that may be used to implement an embodiment.

FIG. 3 is flowchart of a method of relating resources and business objects, according to an embodiment.

FIG. 4 shows an example of an object view, according to an embodiment.

FIG. 5 shows an example of a resource view, according to an embodiment.

FIG. 6 is a block diagram of an example computer system and network for implementing embodiments.

### DETAILED DESCRIPTION

Described herein are techniques for relating resources and business objects in an enterprise data processing environment. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In this document, various methods, processes and procedures are detailed. Although particular steps may be described in a certain order, such order is mainly for convenience and clarity. A particular step may be repeated more than once, may occur before or after other steps (even if those steps are otherwise described in another order), and may occur in parallel with other steps. A second step is required to follow a first step only when the first step must be completed before the second step is begun. Such a situation will be specifically pointed out when not clear from the context. A particular step may be omitted; a particular step is required only when its omission would materially impact another step.

In this document, the terms “and”, “or” and “and/or” are used. Such terms are to be read as having the same meaning; that is, inclusively. For example, “A and B” may mean at least the following: “both A and B”, “only A”, “only B”, “at least both A and B”. As another example, “A or B” may mean at least the following: “only A”, “only B”, “both A and B”, “at least both A and B”. When an exclusive-or is intended, such will be specifically noted (e.g., “either A or B”, “at most one of A and B”).

In this document, various computer-implemented methods, processes and procedures are described. It is to be understood that the various actions (receiving, storing, sending, communicating, displaying, etc.) are performed by a hardware device, even if the action may be authorized, initiated or triggered by a user, or even if the hardware device is controlled by a computer program, software, firmware, etc. Further, it is to be understood that the hardware device is operating on data, even if the data may represent concepts or real-world objects, thus the explicit labeling as “data” as such is omitted. For example, when the hardware device is described as “storing a record”, it is to be understood that the hardware device is storing data that represents the record.

The term “business object” is used in this document. Whereas a computer program may implement classes (which typically end in objects managing or executing behaviors), a business object usually does nothing itself but instead holds a set of instance variables or properties (also known as attributes) and associations with other business objects, weaving a map of objects representing the business relationships. In general, a business object is a code construct (e.g., a data structure) that corresponds directly to a thing in the actual business, where the business uses software (e.g., a computer program) to manipulate the business object as real-world activities take place that are related to the thing. The business object encapsulates the business logic related to the thing, and encapsulates the data that is required by the logic and also describes, defines, makes up, is contained by, or is associated with the thing. In general, the “thing” is recognizable to a non-technical person familiar with the business, like the users, business analysts, etc. For example, in a video rental store business assume things such as video discs, console games, customers, rental orders, late fees, etc. In software representing that business there would be business objects that represent video discs, console games, customers, rental orders, late fees, etc. Each object has data that describes or is attributed to the object and methods that make decisions based on that data. For example, a video disc may have a Title and DateReleased attributes (data), and may have the method <calculate rental price> to determine how much it costs to rent the video disc. Things may be tangible objects with real-world meanings (such as the video discs discussed above), or may be conceptual objects that relate to the business and its business processes (such as a rental agreement or a rental policy).

The general term “business object” may be more precisely stated by using two other terms: business object instance and business object type. A business object instance refers to a specific business object, often including specific data, that is processed by the data processing system; whereas a business object type refers to a general class of business object which may itself serve as a template for business object instances. Example business object types include a purchase order, a sales order, etc.; corresponding instances include a specific purchase order with specific data, a specific sales order with specific data, etc. Embodiments use both business object types (e.g., a particular application may not be configured to access business objects of a particular type) as well as business object instances (e.g., a relationship may link a business object instance with another object); often the general term “business object” may be used to describe both since the more precise term is clear from the context.

The term “resource” is used in this document. In general, a resource may perform (or may be used to perform) an activity in a business or workplace context. A common example of a resource is employees (human resources), etc. A resource may be a type of business object, e.g., an employee business object accessed by a human resources application server.

The term “heterogeneous” is used in this document. In general, two things are heterogeneous when there exists a structural or functional difference between them such that there is no direct interaction between the two things. For example, heterogeneous computer systems may have different hardware (e.g., IBM™ hardware and HP™ hardware).

Heterogeneous computer systems may execute different operating systems (e.g., Linux™ operating system and Microsoft Windows™ operating system). Heterogeneous computer systems may execute different application programs (e.g., an inventory management application and a customer relationship management application). Indirect interaction between heterogeneous computer systems may be provided via a network. For example, each computer system is configured to connect to the network, and thus is ambivalent regarding the structure or function of the other computer system. A single hardware device may execute heterogeneous application programs that interact indirectly, for example via a common operating system.

A system may also be heterogeneous when it uses two (or more) types of business objects, one type of which is accessed by one subsystem (application, etc.) and another type of which is accessed by the other subsystem (application, etc.), and one subsystem cannot directly access the type of business objects accessed by the other. For example, two applications may be heterogeneous when one application is not configured to access (e.g., is unable to access) a particular type of business object that the other application is configured to access. In addition, the two different types of business objects may be described as being heterogeneous.

Heterogeneous may be contrasted with homogeneous. Note that many existing resource scheduling systems, such as those described in the Background, are homogeneous systems and thus omit the descriptor “homogeneous”. In the absence of the descriptor “homogeneous”, one of ordinary skill in the art may recognize a homogeneous system by its features. For example, if a scheduling system has only a single application, that system is homogeneous because all business objects stored by that system are accessible by that single application. As another example, if the business objects in a system are all directly accessible by two different applications in the system, those applications are homogeneous. As a further example, if a particular type of business object in a system is directly accessible by two different applications in the system, those applications are homogeneous with respect to that particular type of business object.

The terms “resource scheduling” and “resource assignment” are used in this document. These terms are generally synonymous, except as follows: Resource scheduling more precisely refers to an automated (machine-made) relation between a resource and a business object, whereas resource assignment more precisely refers to a non-automated (non-machine-made) relation between a resource and a business object. Such precision is not usually required for certain embodiments, or the intended term may be clear from context, so the following description generally uses the two terms interchangeably.

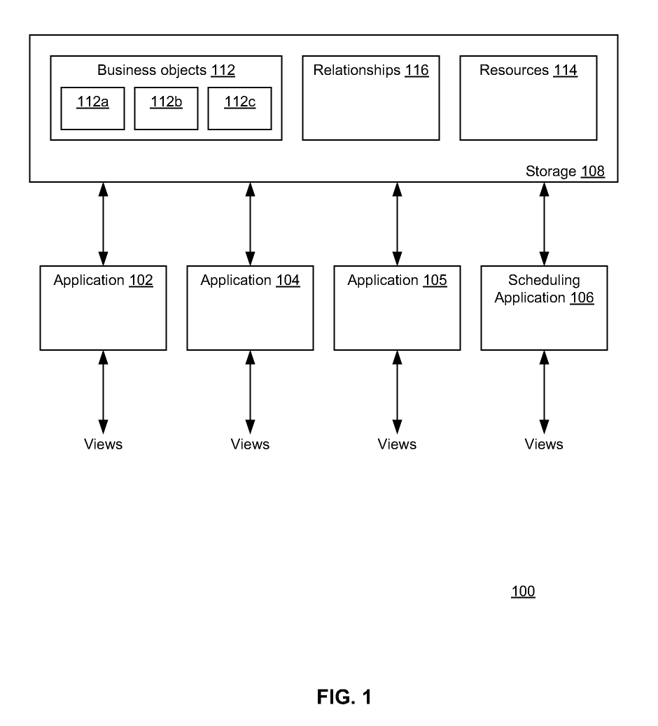

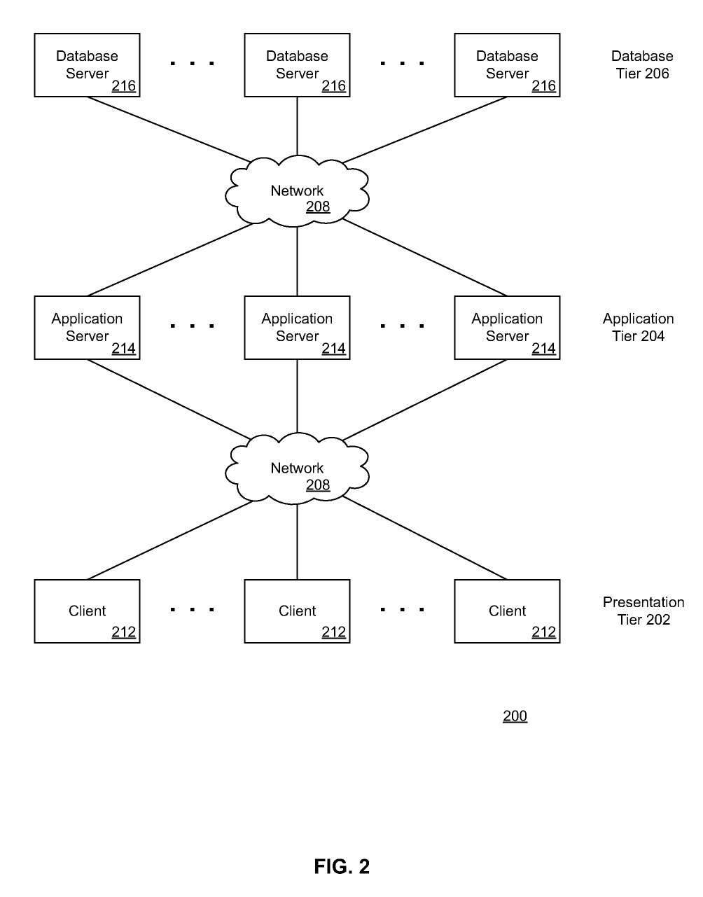

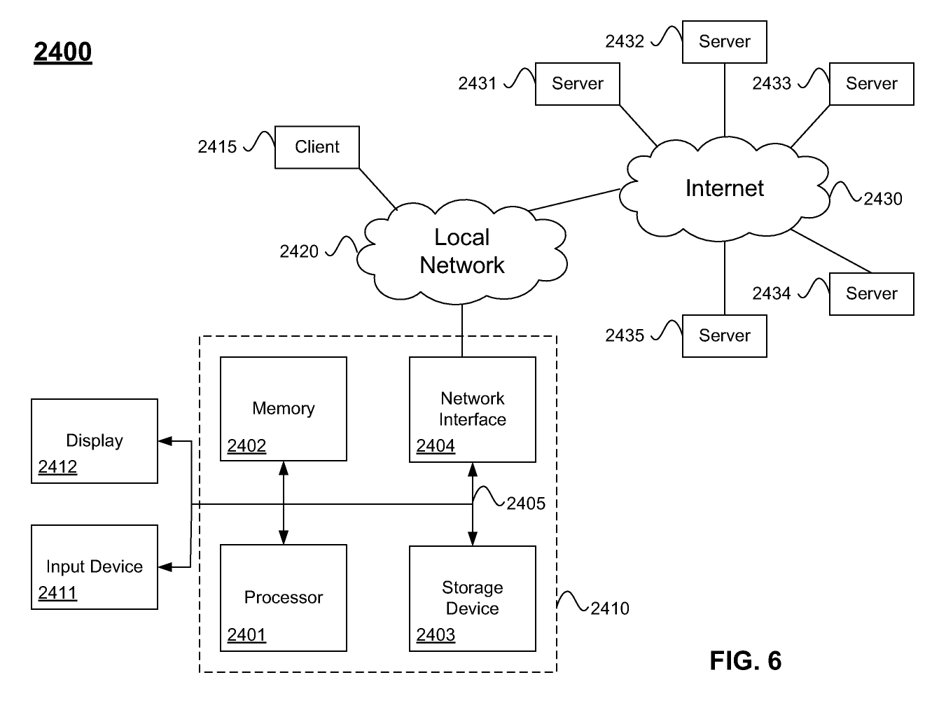

FIG. 1 is a block diagram of a system 100 for relating resources and business objects, according to an embodiment. FIG. 1 is a functional diagram from the perspective of the applications; specific hardware implementations of the system 100 are shown in FIG. 2 and FIG. 6. The system 100 includes an application 102, an application 104, an application 105, an application 106, and storage 108.

The storage 108 stores data used by the applications 102, 104, 105 and 106. This data includes business objects 112, resources 114, and relationships 116 between the business objects 112 and the resources 114. The business objects 112 have more than one type, and not all of the applications 102 and 104 are able to access all types of business objects (e.g., the applications 102 and 104 are heterogeneous). More specifically, the application 102 accesses the business objects 112a (read/write) but cannot access the business objects 112b; the application 104 accesses the business objects 112b (read/write) but cannot access the business objects 112a; both applications 102 and 104 may access the business objects 112c; the application 105 accesses the resources 114 (read/write); and the application 106 accesses the business objects 112 (read), the resources 114 (read), and the relationships 116 (read/write). The storage 108 may be implemented by one or more hardware devices as shown in FIG. 2 and FIG. 6.

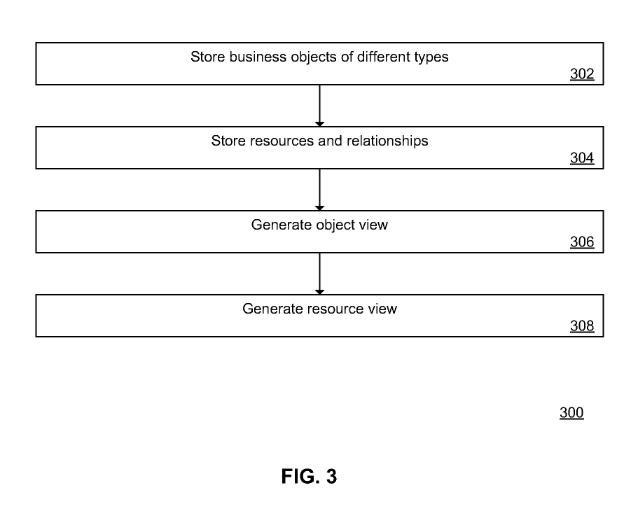

Examples of the applications 102 and 104 include an invoice processing application, a supply chain management application, a customer relationship management application, etc. Although two applications 102 and 104 are shown, the system 100 may implement any number of applications. An example of the application 105 is a human resources application. The application 106 is a scheduling application. More details of the application 106 are provided below with reference to FIG. 3. The applications 102, 104, 105 and 106 receive input (e.g., from users) and generate output (e.g., views of data to users).

As a more specific example, assume that application 102 is an order management system managing one type of business object 112a (sales orders, including a specific Sales Order #334455); application 104 is a service management system managing another type of business object 112b (service orders, including a specific Service Order #998877); the application 105 is a human resources system managing the resources 114 (human resources, including a specific human resource John Doe); and the application 106 is a scheduling system managing the relationships 116. The scheduling system (application 106) manages a first relationship between Sales Order #334455 and John Doe, and a second relationship between Service Order #998877 and John Doe.

The applications 102 and 104 are heterogeneous applications. As heterogeneous applications, the business objects 112 accessed (edited, created, deleted, changed, manipulated, etc.) by one application may not be directly accessed by the other application. For example, an invoice processing application 102 accesses invoice business objects 112a, and a customer relationship management application 104 accesses customer business objects 112b; the invoice processing application is unable to directly access the customer business objects, and the customer relationship management application is unable to directly access the invoice business objects.

Access to business objects may be implemented in various ways, depending in large part upon the specific software and hardware choices made to implement the system 100 (see, e.g., FIG. 2 and FIG. 6). One way to implement access is via application programming interfaces (APIs). For example, the server that implements the applications 102 and 104 may implement a common programming environment that uses APIs to build applications; the applications 102 and 104 are then built using those APIs and execute in the common programming environment.

The system 100 may have different APIs for accessing different types of business objects 112a and 112b. For example, a project management application uses the APIs specific to project structure business object (or to be precise: business objects of this business object type), and a customer relationship management application uses the APIs specific to sales order business objects. Since the project management processing application does not use the APIs specific to the sales order business objects, the project management application does not have direct access to the sales order business objects. Since the customer relationship management application does not use the APIs specific to the project structure business objects, the customer relationship management application does not have direct access to the project structure business objects. Thus, the project management application and the customer relationship management application are heterogeneous applications.

As a more specific example, the system 100 may implement a SAP NetWeaver™ environment in which access to business objects is provided by BAPIs (Business Application Programming Interfaces). The system 100 may then use the BAPIs to implement various SAP NetWeaver™ applications, such as applications for supplier relationship management, customer relationship management, supply chain management, product lifecycle management, enterprise resource management, business intelligence, identity management, and master data management.

FIG. 2 is a block diagram of a three tier architecture system 200 that may be used to implement an embodiment. The system 200 includes a presentation tier 202, an application tier 204, and a database tier 206. A network 208 connects the devices within and between the tiers. The network 208 may include one or more networks, such as a local area network, a wide area network, or the internet.

The presentation tier 202 generally includes one or more client computers 212. The client computers 212 generally provide a graphical user interface for users to interact with the other parts of the system 200. The user interface may be implemented by a browser, for example as a Java application.

The application tier 204 generally includes one or more application servers 214. The application servers 214 generally implement the business logic for processing interactions between the users and the underlying data. This business logic is generally referred to as “the application” or “the application program”. The application tier 204 may implement various applications to perform various functions, such as invoicing, inventory control, supply chain management, etc. Various of the application servers 214 may perform different functions. For example, one of the application servers 214 may be used for prototyping or development, while the others may be used for business intelligence production activities.

The database tier 206 generally includes one or more database servers 216. The database servers 216 generally implement a database management system that stores and manipulates the underlying data and related metadata. This database management system is generally referred to as “the database” or “the database system” or “the database program”. The database servers 216 may implement various types of database systems, including DB2, Informix, SAP MaxDB, Oracle and Microsoft SQL Server™.

Although many separate devices are shown in each tier, such is mainly for illustration purposes to show scalability. For example, a single database server may be used in the basic configuration, but as the amount of data in the databases increases, the number of database servers 216 may be increased. As another example, a single application server may be used in the basic configuration, but as the amount of business logic processes increases, the number of application servers 214 may be increased. Furthermore, in certain embodiments the tiers may be combined on a single computing device. For example, a single computing device may have multiple processors or multiple blades; one blade may implement a database server and another blade may implement an application server. In another embodiment, a single database server 216 and a single application server 214 may be implemented by a single computing device.

The system 200 may be implemented in a variety of operating systems, for example, UNIX (AIX, HP-UX, Solaris, Linux), Microsoft Windows, IBM Series i (former iSeries, AS/400) and IBM zSeries (former S/390). The various devices in the various tiers may implement different operating systems. For example, a client computer 212 may run Microsoft Windows™ and an application server 214 may implement Linux. Note that various devices generally implement both an operating system program and another program, which are distinct. For example, a client computer 212 may implement Microsoft Windows™ (operating system) and Microsoft Internet Explorer™ (user interface program). An application server 214 may implement Linux (operating system) and an invoicing system (application program). A database server 216 may implement Linux (operating system) and Oracle database (database program).

The SAP Web Application Server™ is a specific example of an implementation of the system 200. An embodiment of the system 100 (see FIG. 1) generally involves two or more application programs (at the application server 214) and a storage system (at the database server 216). The various elements of the system 100 may be variously implemented by the system 200. For example, a single application server may implement the applications 102, 104, 105 and 106. As another example, one application server may implement the applications 102 and 106, another application server may implement the application 104, and yet another application server may implement the application 105. As another example, one application server may implement the applications 104 and 106, and another application server may implement the application 102; the application 105 may be implemented by one of these application servers or by yet another application server. As another example, one application server may implement the application 102, another application server may implement the application 104, and yet another application server may implement the application 106; the application 105 may be implemented by one of these application servers or by yet another application server.

FIG. 3 is flowchart of a method 300 of relating resources and business objects, according to an embodiment. The method 300 may be performed by the system 100 (see FIG. 1), for example by executing one or more computer programs. The system 200 (see FIG. 2) may implement the system 100, or the method 300, at the hardware level.

At 302, two or more application servers store business objects having more than one business object type. One application server accesses business objects of a first type and the second application server accesses business objects other than those of the first type. For example, in the system 200 (see FIG. 2), one of the application servers 214 may implement the applications 102, 104, 105 and 106 (see FIG. 1). One of the database servers 216 stores the business object types 112. The application server 214 interacts with the database server 216 to access the business object types 112. The application 102 may access the business objects 112a but not the business objects 112b.

As part of the normal operation of the application servers, they present views to users and interface between the users and the underlying storage (as shown in FIG. 1). The users may perform the normal business activity associated with the applications (e.g., invoicing, supply chain management, customer relationship management, etc.), including editing (creating, deleting, etc.) business objects, business object instances, and related data such as attributes. The applications may be built using APIs or BAPIs as discussed above.

The application servers may be heterogeneous; the applications may be heterogeneous. As an example, assume two heterogeneous applications: an invoicing application and a supply chain management application; further assume they are implemented on separate hardware servers that interact with a database server (storage). The invoicing application interacts with business objects of the type invoice stored by the database server, and the supply chain management application interacts with supply chain management business object types stored by the database server. Examples of these interactions by the invoicing application include creating, deleting, editing, copying, and modifying the invoice business objects (and instances thereof and data related thereto), and creating new types of invoice business objects. The same types of interactions may be performed by the supply chain management application. Since the applications are heterogeneous, the invoicing application can delete business objects and create new business objects without any required modification or interaction with the supply chain management application. Similarly, the supply chain management application can delete business objects and create new business objects without any required modification or interaction with the invoicing application.

At 304, an application server stores resources and relationships. The relationships are between the business objects (see 302) and the resources. For example, in the system 200 (see FIG. 2), one of the application servers 214 may implement the applications 102, 104, 105 and 106 (see FIG. 1). One of the database servers 216 stores the resources 114 and the relationships 116. The application server 214 interacts with the database server 216 to access the resources 114 and the relationships 116. The database servers and application servers that store the resources and relationships may be the same as store the business objects (see 302), or separate devices may be used to implement the applications and to store the business objects, the resources and the relationships.

More specifically, one of the application servers 214 (see FIG. 2) may implement the application 105 (see FIG. 1) that manages the resources, and another may implement the scheduling application 106 that manages the relationships. For example, the resources 114 may be represented by resource business objects that the scheduling application presents to users. The scheduling application 106 may also access the business objects 112 and present them to the users. As the relationships 116 relate the business objects and the resources, the scheduling application 106 may present the relationships to the users that the users can access, thereby editing (adding, deleting, changing, modifying, etc.) the relationships between the business objects 112 and the resources 114 (see also 306 and 308 below).

A wide variety of relationship attributes may be implemented according to various embodiments, including a validity period attribute, a duration limit attribute, a duration estimate attribute, an activity type attribute, and a flexible attribute (a customer specific, deployment specific or implementation specific attribute). The validity period attribute specifies that the resource is to be associated with the business object within specified start and end times. The duration limit attribute specifies that the resource is to be associated with the business object for a specified duration. The duration estimate attribute specifies that the resource is to be associated with the business object for an estimated specified duration. The activity type attribute specifies that the resource is to be associated with the business object for a specified activity type. (Activity types specify the business context (or use) between a resource and a business object. For example, consider activity types to differentiate the kind of jobs done by human resources in a project). The service attributes provide a flexible way to add and use new attributes that may be used for implementing a specific business use case. For example, consider that service providers may want to specify whether or not the assignment (relationship) of a service professional (resource) to a customer engagement (business object) has a revenue impact or not (e.g., service attribute=“billable/non billable”). Various instances of the relationship with respect to the same attribute may be supported. For example, consider that a relationship between one resource and one business object can be created for the same duration and start/end date, but for two different activity types.

At 306, an object view is generated. In the object view, business objects and their related resources, along with the associated relationships and relationship attributes, are displayed. A business object may be selected and the relationship attributes for the resources associated with the selected business object are editable according to user input. Editing the relationship attributes changes the relationships between the selected business object and the associated resources. “Editing” includes adding, deleting, removing, changing, modifying, etc. For example, in the system 200 (see FIG. 2), one of the application servers 214 may execute the scheduling application 106 (see FIG. 1), which presents the object view as one of the views presented to users (e.g., by one of the clients 212). The user may select a business object using the human interface tools of the client 212 (e.g., mouse, keyboard, etc. as shown in FIG. 6). The user may edit the relationship attributes of the selected business object using the human interface tools. The application server 214 then stores the edited information in the storage 108 (e.g., via one of the database servers 216).

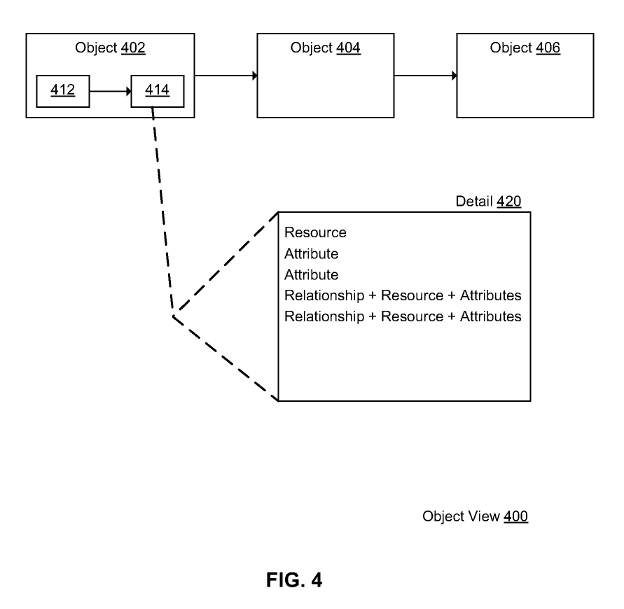

A variety of user input may be processed in the object view. One or more business objects may be selected. The business objects may have the same business object type. Resources associated with a business object may be added or removed, for example by editing the relationship attributes of the relationships of the selected business object. The relationships between a business object and a resource may be edited, for example by editing the relationship attributes of the relationships. Further details of the object view are provided with reference to FIG. 4.

At 308, a resource view is generated. In the resource view, resources and their related business objects, along with the associated relationships and relationship attributes, are displayed. A resource may be selected and the associated business objects and associated relationships are viewable. According to a favored embodiment, the relationships and attributes are not editable in the resource view. A goal of this embodiment is to enable a visualization of the existing relationships from a resource centric perspective. Often in various business requirements contexts, it is desirable to perform editing in the object view and not to perform editing in the resource view.

According to another embodiment, relationships and attributes may be edited in the resource view in a manner similar to that of the object view. A resource may be selected and the relationship attributes for the business objects associated with the selected resource are editable according to user input. Editing the relationship attributes changes the relationships between the selected resource and the associated business objects. For example, in the system 200 (see FIG. 2), one of the application servers 214 may execute the scheduling application 106 (see FIG. 1), which presents the resource view as one of the views presented to users (e.g., by one of the clients 212). The user may select a resource using the human interface tools of the client 212 (e.g., mouse, keyboard, etc. as shown in FIG. 6). The user may edit the relationship attributes of the selected resource using the human interface tools. The application server 214 then stores the edited information in the storage 108 (e.g., via one of the database servers 216).

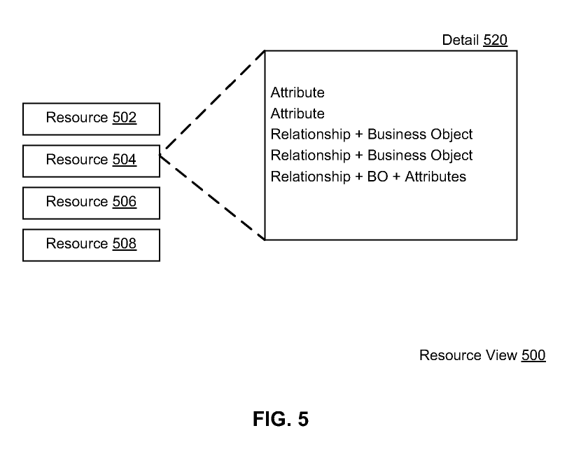

A variety of user input may be processed in the resource view. One or more resources may be selected. Business objects associated with a resource may be added or removed, for example by editing the relationship attributes of the relationships of the selected resource. The relationships between a resource and a business object may be edited, for example by editing the relationship attributes of the relationships. Further details of the resource view are provided with reference to FIG. 5.

The method 300 may be implemented by one or more computer programs. In one embodiment, an application server (e.g., one of the application servers 214 of FIG. 2) executes a storage component and a view generator component. The application server 214 implements the applications 102, 104, 105 and 106 (see FIG. 1). The application server 214 executes the storage component to store the business objects 112a and 112b (see 302), as part of executing the applications 102 and 104. The application server 214 executes the storage component to store the resources 114 (see 304), as part of executing the application 105; and the relationships 116 (see 304), as part of executing the scheduling application 106. The application server 214 executes the view generator component to generate the object view 400 (see 306). The application server 214 executes the view generator component to generate the resource view 500 (see 308). The application server 214 may interact with other components as part of implementing the method 300, for example with the database servers 216 to store the business objects 112, the resources 114 and the relationships 116; and with the clients 212 to display the views and to process user input.

FIG. 4 shows an example of an object view 400, according to an embodiment. The object view 400 shows three business objects 402, 404 and 406 that are representing the IT view on a business context, e.g. three phases of one project. The business object 402 includes two subordinate business objects 412 and 414. The object view 400 is editable as described in 306 (see FIG. 3).

The object view 400 shows that the business object 414 is selected. For the selected business object 414, the object view 400 shows a detail view 420. The detail view 420 shows the details of the selected business object. For the business object 414, the associated resource 1 is displayed together with two attributes. A second relationship to resource 2 and attributes, and a third relationship to resource 3 together with associated attributes, are also displayed. For example, consider that the business object 402 represents phase 1 of a customer project and the business object 414 represents the workpackage “Requirements Determination”. Senior advisor Marc White (resource 1) has been assigned for 25 days in 2011 (attributes), while junior advisors Sam Brown (resource 2) and Phil Dark (resource 3) are assigned for 10 days each (attribute).

When implemented by the system 200 (see FIG. 2), one of the clients 212 may display the object view 400 based on data provided by one of the application servers 214 that implements the scheduling application 106 (see FIG. 1). The data displayed in the object view 400 include data stored by one or more of the database servers 216, including the business objects 112, the resources 114 and the relationships 116. A user may then manipulate the displayed data using the human interface tools of the client 212 (see FIG. 6).

FIG. 5 shows an example of a resource view 500, according to an embodiment. The resource view 500 shows a list of resources 502, 504, 506 and 508. According to an embodiment, the resource view 500 is implemented through reporting. The resource view 500 is a detailed example showing various relationship attributes that are accessible as described in 308 (see FIG. 3).

The resource view 500 shows that the resource 504 is selected. For the selected resource 504, the resource view 500 shows a detail view 520. The detail view 520 shows the details of the selected resource. For the resource 504, the details include two attributes, a first relationship and associated business object, a second relationship and associated business object, and a third relationship with an associated business object and an associated attribute. The resource view 500 allows a user to see the different business object types that the resource is related to (and the associated attributes). For example: The resource view shows in March, Mark White is assigned to one customer project (one type of business object) and to two customer sales orders (another type of business object).

A user may easily switch between the object view 400 (see FIG. 4) and the resource view 500 (see FIG. 5). For example, when the client 212 (see FIG. 2) includes a mouse, and in the object view 400 the business object 414 is selected, the user may click on a resource in the detail view 420; the client 212 then may switch to the resource view 500 and may display the detail view 520 for that resource. Similarly, when in the resource view 500 the resource 504 is selected, the user may click on a business object in the detail view 520; the client 212 then may switch to the object view 400 and may display the detail view 420 for that business object.

FIG. 6 is a block diagram of an example computer system and network 2400 for implementing embodiments. Computer system 2410 includes a bus 2405 or other communication mechanism for communicating information, and a processor 2401 coupled with bus 2405 for processing information. Computer system 2410 also includes a memory 2402 coupled to bus 2405 for storing information and instructions to be executed by processor 2401, including information and instructions for performing the techniques described above. This memory may also be used for storing temporary variables or other intermediate information during execution of instructions to be executed by processor 2401. Possible implementations of this memory may be, but are not limited to, random access memory (RAM), read only memory (ROM) (when not storing temporary variables or other intermediate information), or both. A storage device 2403 is also provided for storing information and instructions. Common forms of storage devices include, for example, a hard drive, a magnetic disk, an optical disk, a CD-ROM, a DVD, a flash memory, a USB memory card, a solid state drive, or any other medium from which a computer can read. Storage device 2403 may store source code, binary code, or software files for performing the techniques or embodying the constructs above, for example.

Computer system 2410 may be coupled via bus 2405 to a display 2412, such as a cathode ray tube (CRT) or liquid crystal display (LCD), for displaying information to a computer user. An input device 2411 such as a keyboard and/or mouse is coupled to bus 2405 for communicating information and command selections from the user to processor 2401. The combination of these components allows the user to communicate with the system. In some systems, bus 2405 may be divided into multiple specialized buses.

Computer system 2410 also includes a network interface 2404 coupled with bus 2405. Network interface 2404 may provide two-way data communication between computer system 2410 and the local network 2420. The network interface 2404 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 2404 sends and receives electrical, electromagnetic, or optical signals that carry digital data streams representing various types of information.

Computer system 2410 can send and receive information, including messages or other interface actions, through the network interface 2404 to an Intranet or the Internet 2430. In the Internet example, software components or services may reside on multiple different computer systems 2410 or servers 2431, 2432, 2433, 2434 and 2435 across the network. A server 2431 may transmit actions or messages from one component, through Internet 2430, local network 2420, and network interface 2404 to a component on computer system 2410.

The computer system and network 2400 may be configured in a client server manner. For example, the computer system 2410 may implement a server. The client 2415 may include components similar to those of the computer system 2410.

More specifically, the client 2415 may implement one of the clients 212 (see FIG. 2), which displays the views provided by the applications 102, 104, 105 and 106 (see FIG. 1) and otherwise accepts user input to interact with the applications. The server 2431 may implement one of the database servers 216 that stores the business objects 112, the resources 114 and the relationships 116. The computer 2410 may implement one of the application servers 214 that executes the scheduling application 106. The server 2432 may implement one of the application servers 214 that executes the applications 102, 104 and 105.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method of relating resources and business objects, comprising:
storing a plurality of business objects of a plurality of business object types by a plurality of application servers including a first application server and a second application server, wherein the first application server is configured to access a business object of a first business object type and the second application server is configured not to access the business object of the first business object type;
storing a plurality of resources, and a plurality of relationships between the plurality of business objects and the plurality of resources;
generating an object view in which, for a selected business object of the plurality of business objects, a first relationship of the plurality of relationships is editable according to a first user input, wherein the first relationship relates the selected business object to one of the plurality of resources; and
generating a resource view in which, for a selected resource of the plurality of resources, at least one associated business object and at least one associated relationship are viewable, wherein the at least one associated relationship relates the selected resource and the at least one associated business object.

2. The computer-implemented method of claim 1, wherein the first user input changes the one of the plurality of resources to another of the plurality of resources.

3. The computer-implemented method of claim 1, wherein the first user input changes the plurality of relationships.

4. The computer-implemented method of claim 1, wherein the first user input deletes an existing relationship of the plurality of relationships between the selected business object and the plurality of resources.

5. The computer-implemented method of claim 1, wherein the first user input adds a new relationship in the plurality of relationships between the selected business object and the plurality of resources.

6. The computer-implemented method of claim 1, wherein in the resource view, for the selected resource, a second relationship of the plurality of relationships is editable according to a second user input, wherein the second relationship relates the selected resource to one of the plurality of business objects.

7. The computer-implemented method of claim 6, wherein the second user input changes the one of the plurality of business objects to another of the plurality of business objects.

8. The computer-implemented method of claim 6, wherein the second user input changes the plurality of relationships.

9. The computer-implemented method of claim 6, wherein the second user input deletes an existing relationship of the plurality of relationships between the selected resource and the plurality of business objects.

10. The computer-implemented method of claim 6, wherein the second user input adds a new relationship in the plurality of relationships between the selected resource and the plurality of business objects.

11. The computer-implemented method of claim 6, wherein the first relationship is the second relationship.

12. The computer-implemented method of claim 1, wherein a relationship attribute of a relationship of the plurality of relationships includes one of a validity period attribute, a duration limit attribute, a duration estimate attribute, an activity type attribute, and a flexible attribute.

13. The computer-implemented method of claim 1, wherein the first application server and the second application server are heterogeneous.

14. The computer-implemented method of claim 1, wherein the first application server and the second application server are implemented by a plurality of heterogeneous applications in a single hardware server.

15. A system for relating resources and business objects, comprising:
a first application server;
a second application server, wherein the first application server and the second application server are configured to store a plurality of business objects of a plurality of business object types, wherein the first application server is configured to access a business object of a first business object type and the second application server is configured not to access the business object of the first business object type;
a third application server that is configured to store a plurality of resources; and
a fourth application server that is configured to store a plurality of relationships between the plurality of business objects and the plurality of resources,
wherein the fourth application server is configured to generate an object view in which, for a selected business object of the plurality of business objects, a first relationship of the plurality of relationships is editable according to a first user input, wherein the first relationship relates the selected business object to one of the plurality of resources, and
wherein the fourth application server is configured to generate a resource view in which, for a selected resource of the plurality of resources, at least one associated business object and at least one associated relationship are viewable, wherein the at least one associated relationship relates the selected resource and the at least one associated business object.

16. The system of claim 15, further comprising:
a plurality of heterogeneous hardware servers that implement the first application server, the second application server and the third application server.

17. The system of claim 15, further comprising:
a single hardware server that implements the first application server, the second application server and the third application server using a plurality of heterogeneous applications.

18. The system of claim 15, further comprising:
a database server that interacts with the first application server, the second application server, the third application server, and the fourth application server to store the plurality of business objects, the plurality of resources and the plurality of relationships.

19. The system of claim 15, further comprising:
a plurality of hardware servers that implement the first application server, the second application server, the third application server, and the fourth application server; and
a database server that interacts with the plurality of hardware servers to store the plurality of business objects, the plurality of resources and the plurality of relationships.

20. A non-transitory computer readable medium storing instructions to control a computer system for relating resources and business objects, comprising:
a first storage component, executed by a plurality of application servers including a first application server and a second application server, that controls the plurality of application servers to store a plurality of business objects of a plurality of business object types, wherein the first application server is configured to access a business object of a first business object type and the second application server is configured not to access the business object of the first business object type;
a second storage component, executed by a third application server, that controls the third application server to store a plurality of resources;
a third storage component, executed by a scheduling application server, that controls the scheduling application server to store a plurality of relationships between the plurality of business objects and the plurality of resources;
a first view generator component, executed by the scheduling application server, that controls the scheduling application server to generate an object view in which, for a selected business object of the plurality of business objects, a first relationship of the plurality of relationships is editable according to a first user input, wherein the first relationship relates the selected business object to one of the plurality of resources; and
a second view generator component, executed by the scheduling application server, that controls the scheduling application server to generate a resource view in which, for a selected resource of the plurality of resources, at least one associated business object and at least one associated relationship are viewable, wherein the at least one associated relationship relates the selected resource and the at least one associated business object.
